(19) United States
(12) Patent Application Publication
(10) Pub. No.: US 2008/0115996 A1
(43) Pub. Date: May 22, 2008

(54) COOLING FAN FOR A MOTORCYCLE

(75) Inventors: Benjamin M. Wright, Sullivan, WI (US); Matthew Peller, Milwaukee, WI (US); Dean Lax, Brownsville, WI (US); Scott Hinze, Cedarburg, WI (US)

Correspondence Address: MICHAEL BEST & FRIEDRICH LLP, 100 E WISCONSIN AVENUE, Suite 3300, MILWAUKEE, WI, 53202, US

(73) Assignee: Harley-Davidson Motor Company Group, Inc., Milwaukee, WI (US)

(21) Appl. No.: 11/552,559

(22) Filed: Oct. 25, 2006

(51) Int. Cl. B62K 11/00

(52) U.S. Cl. 180/219

(57) ABSTRACT

A side cover assembly configured for use with a motorcycle. The side cover assembly includes a side cover, an inlet, an outlet vent, and a fan assembly. The side cover is adapted to be coupled to the motorcycle, and the side cover includes an interior surface facing an interior side and adapted to face at least a portion of the motorcycle, and an exterior surface facing an exterior side opposite the interior side. The inlet and outlet vent are at least partially defined by the side cover. The fan assembly is coupled to the side cover, and the fan assembly is operable to draw air from the exterior side and into the interior side through the inlet and discharge at least a portion of the air from the interior side to the exterior side through the outlet vent.

### BACKGROUND

The present invention relates to motorcycles, and more specifically to cooling fans for motorcycles.

A motorcycle typically includes a rear wheel and a front wheel that pivots about an axis to steer the motorcycle. An engine is generally located between the front and rear wheels and is operable to drive the rear wheel. Typically, a seat is located between the front and rear wheels and near the engine. The seat supports a rider that operates the motorcycle and a passenger behind the rider. The rider and passenger typically rest their feet on footboards or footpegs that can be located adjacent the engine, and as a result the rider's and passenger's legs extend adjacent the engine from the seat toward the footboard or footpegs.

### SUMMARY

The present invention provides a side cover assembly configured for use with a motorcycle. The side cover assembly includes a side cover, an inlet, an outlet vent, and a fan assembly. The side cover includes an interior surface facing an interior side and adapted to face at least a portion of the motorcycle, and an exterior surface facing an exterior side opposite the interior side. The inlet and the outlet vent are at least partially defined by the side cover. The fan assembly is coupled to the side cover, and the fan assembly is operable to draw air from the exterior side and into the interior side through the inlet and discharge at least a portion of the air from the interior side to the exterior side through the outlet vent.

The present invention also provides a motorcycle including a frame defining a first side, a second side, a front portion, and a rear portion. The motorcycle further includes a side cover assembly coupled to one of the first and second sides. The side cover assembly includes a fan assembly and a side cover. The fan assembly is coupled to the side cover and is operable to discharge air in the forward direction.

The present invention also provides a method of operating a motorcycle having a side cover that at least partially defines an inlet and an outlet vent, and a fan assembly coupled to the side cover. The method includes activating operation of a fan of the fan assembly, drawing air through the inlet, and discharging at least a portion of the air through the outlet vent. The method further includes directing the air exiting the outlet vent over a leg of a rider of the motorcycle and cooling the leg of the rider with the air exiting the outlet vent.

Other aspects of the invention will become apparent by consideration of the detailed description and accompanying drawings.

### BRIEF DESCRIPTION OF THE DRAWINGS

FIG. 1a is a side view of a right side of a motorcycle employing a side cover assembly embodying the present invention.

FIG. 1b is a side view of a left side of the motorcycle of FIG. 1a.

FIG. 2 is an enlarged side view of the side cover assembly of FIG. 1a

FIG. 3 is a section view of the side cover assembly taken along line 3-3 of FIG. 2.

FIG. 4 is an exploded view of the side cover assembly of FIG. 1b.

FIG. 5 is an assembled view of an interior side of the side cover assembly of FIG. 4.

FIG. 6 is a top view of a portion of the motorcycle of FIG. 1a.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

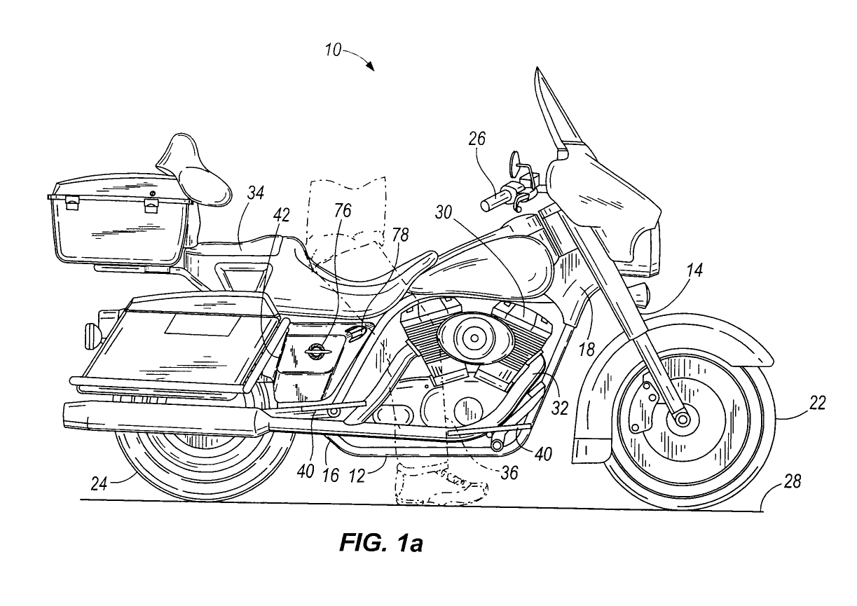

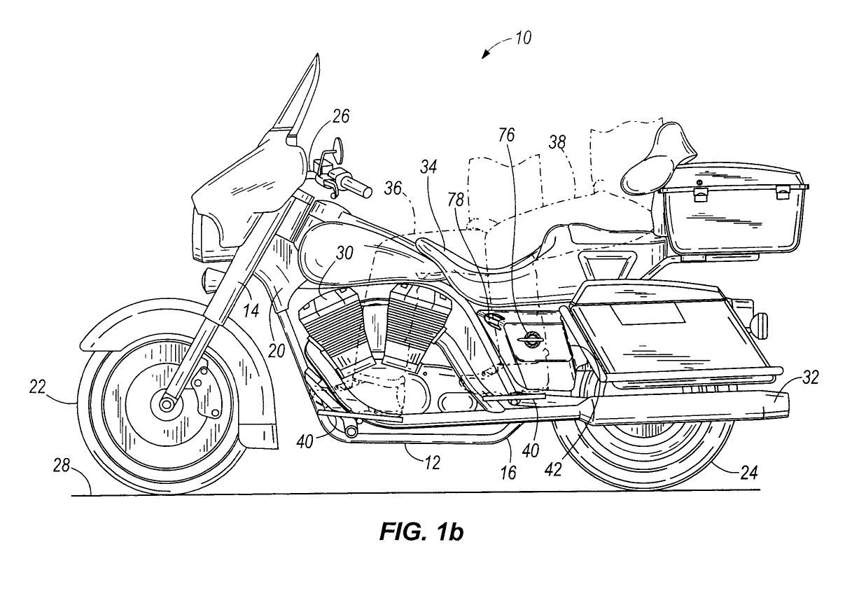

FIGS. 1a and 1b illustrate a motorcycle 10 that includes a frame 12 that defines a front portion 14, a rear portion 16, a first or right side 18 (FIG. 1a), and a second or left side 20 (FIG. 1b). A front wheel 22 and a rear wheel 24 are coupled to the frame 12. The motorcycle 10 further includes a handlebar 26 that can rotate to pivot the front wheel 22 about a steering axis. The front and rear wheels 22, 24 movably support the frame 12 above a surface defining a horizontal plane 28 between the front and rear wheels 22, 24.

The motorcycle 10 further includes an engine 30 that is coupled to the frame 12 between the front and rear wheels 22, 24 and configured to drive the rear wheel 24. The engine 30 can be any suitable engine, such as a one, two, three, four or more cylinder engine that utilizes any suitable fuel. The illustrated motorcycle 10 includes an exhaust system 32 that is in fluid communication with the engine 30 and that extends from the engine 30 toward the rear portion 16 of the motorcycle 10.

A seat 34 is mounted to the frame 12. The seat 34 supports a rider or operator of the motorcycle 10 and in the illustrated construction the seat 34 further supports a second rider or passenger that is located behind the rider. Referring to FIG. 1b, legs 36, 38 of the rider and passenger extend downward from the seat 34 allowing the rider and passenger to rest their feet upon footrests 40.

With continued reference to FIGS. 1a and 1b, a side cover assembly 42 is coupled to each of the right and left sides 18, 20 of the motorcycle 10 below the seat 34. In the illustrated construction, the side cover assemblies 42 are coupled to the right and left sides 18, 20 at generally the same location with respect to the horizontal plane 28 and the front portion 14 of the motorcycle 10. While the illustrated motorcycle 10 includes the side cover assembly 42 on both the right and left sides 18, 20, in other constructions the motorcycle may only include one side cover assembly.

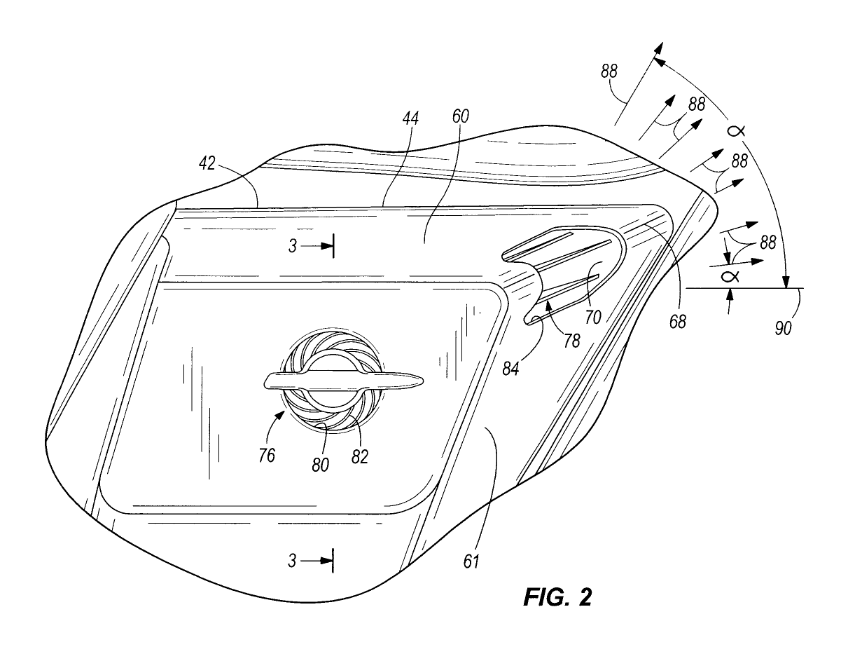

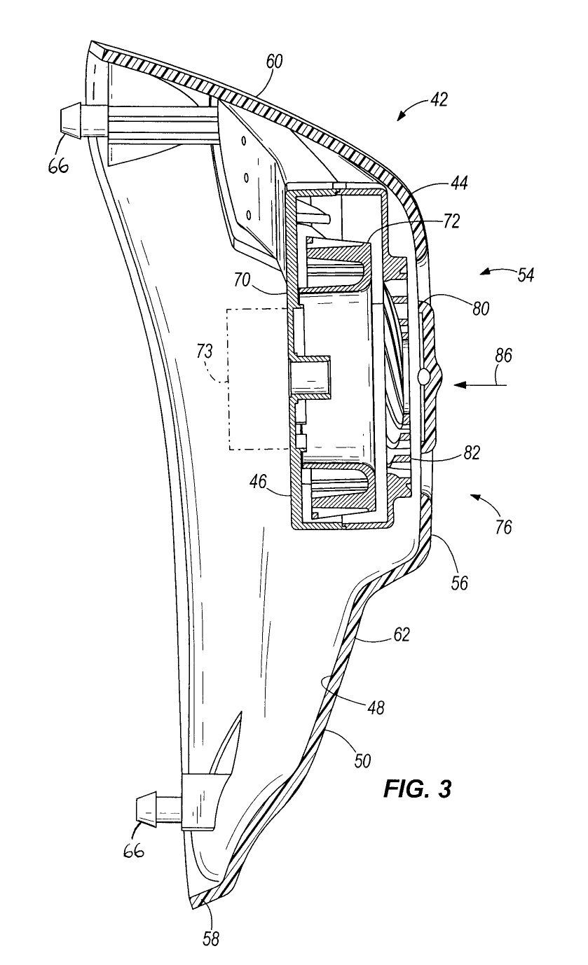

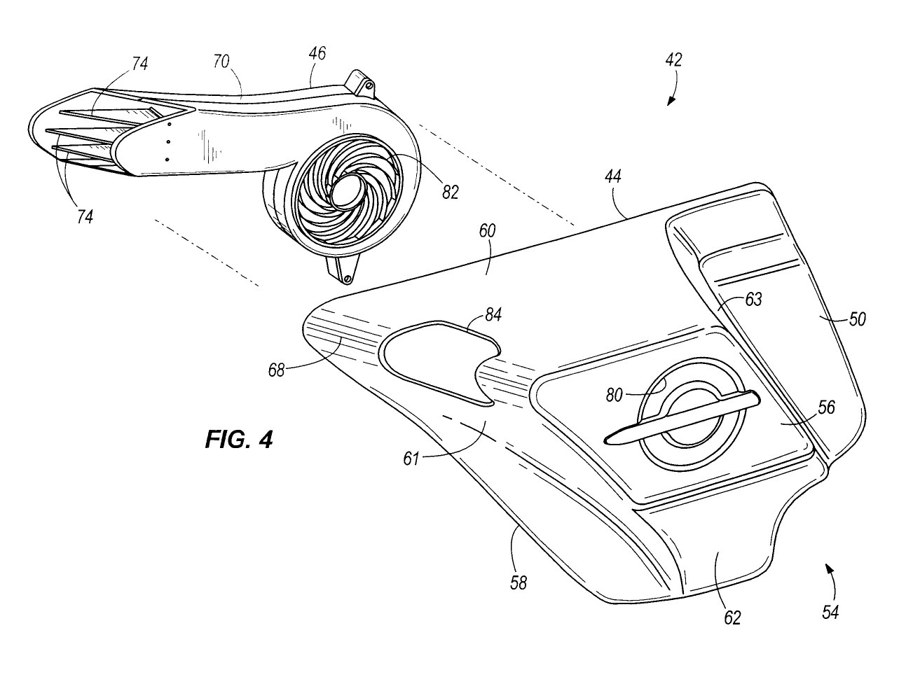

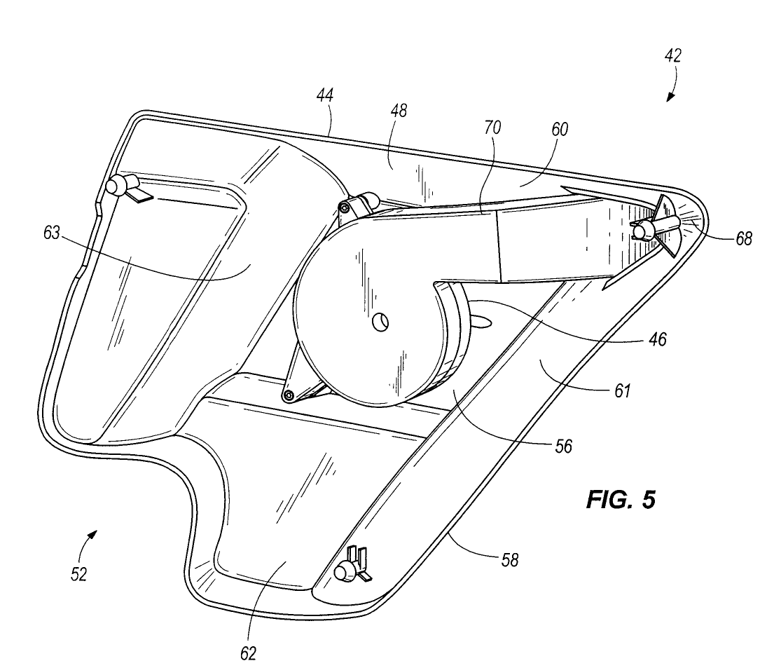

The side cover assemblies 42 of the right and left sides 18, 20 are substantially the same, and therefore the side cover assembly 42 will be described herein interchangeably with regard to both the right and left sides 18, 20 and similar components have been given the same reference numbers. FIGS. 2 and 3 show the side cover assembly 42 adapted for the right side 18 of the motorcycle 10 while FIGS. 4 and 5 show the side cover assembly 42 adapted for the left side 20 of the motorcycle 10.

Referring to FIGS. 4 and 5, the side cover assembly 42 includes a side cover 44 and a fan assembly 46. The side cover 44 is generally concave shaped and includes an interior surface 48 and an exterior surface 50. The interior surface 48 faces an interior side 52 of the side cover 42 and the interior surface 48 faces the motorcycle 10 when the side cover 42 is coupled to the motorcycle 10 as illustrated in FIGS. 1a and 1b. The exterior surface 50 faces an exterior side 54 that is opposite the interior side 52 of the side cover 44.

The illustrated side cover 44 further includes an outboard wall 56 and an edge 58 that is spaced from the outboard wall 56. While the illustrated outboard wall 56 is substantially planar, in other constructions, the outboard wall may be curved or take other suitable profiles.

Referring to FIGS. 3 and 4, the side cover 44 further includes side walls 60, 61, 62, 63 that connect the outboard wall 56 to the edge 58. The illustrated first and second side walls 60, 61 are coupled to define a corner 68. It should be understood that the side walls 60, 61, 62, 63 of the side cover 44 are illustrated in just one possible configuration and in other constructions the side walls can take other forms and can be located in other suitable arrangements with respect to the outboard wall. Furthermore, while the illustrated side cover 44 includes the four side walls 60, 61, 62, 63, in other constructions the side cover can include more or less than four side walls.

The side cover 44 can be formed from any suitable material, such as fiberglass, plastic, composite material, aluminum, and the like using any suitable method, such as casting, molding, machining, etc. Furthermore, in the illustrated embodiment, the side cover 44 is coupled to the motorcycle 10 using posts 66 that are inserted into a rubber aperture of the motorcycle 10. In other embodiments, the side cover can be coupled to the motorcycle using any suitable fastener such as snap-fittings bolts, clamps, screws, adhesives, and the like.

Referring to FIGS. 3, 4 and 5, the fan assembly 46 is coupled to the interior surface 48 of the side cover 44. The fan assembly 46 includes a duct 70 and a fan 72. The fan 72 is positioned within the duct 70, and the fan 72 can be any suitable fan such as an axial fan, a radial fan, and the like. The fan 72 is driven by a drive member 73, such as a motor that can be powered by a battery or other suitable device.

The illustrated duct 70 includes louvers 74 that extend across the duct 70 positioned at a predetermined angle with respect to the duct 70. While the illustrated louvers 74 are fixed with respect to the duct 70, in other constructions the louvers 74 can be movable with respect to the duct 70.

Referring to FIGS. 2 and 3, the side cover assembly 42 further includes an inlet 76 and an outlet vent 78 that are defined by the side cover 44. The inlet 76 includes an inlet aperture 80 that extends through the outboard wall 56 of the side cover 44. In other constructions, the inlet aperture can be located through either of the side walls 60, 61, 62, 63, the outboard wall 56, or a combination thereof. The illustrated duct 70 includes an inlet screen 82 positioned over the inlet 76. In other constructions, the inlet screen can include a filter or other suitable device.

Referring to FIGS. 2 and 4, the outlet vent 78 includes an outlet aperture 84 that is located through both the first and second side walls 60, 61 and through the corner 68 of the side cover 44. In other constructions, the outlet aperture can be located at any suitable location, such as through either of the side walls 60, 61, 62, 63, through the outboard wall 56, or a combination thereof. Referring to FIG. 1b, the side cover assembly 42 is coupled to the motorcycle 10 such that the outlet vent 78 opens toward the front portion 14 of the motorcycle 10.

With continued reference to FIG. 1b, in operation, the rider operates the motorcycle engine 30 to selectively drive the rear wheel 24, and as a result the engine 30 and exhaust system 32 can become warm. The heat from the engine 30 and exhaust system 32 can transfer to the legs 36, 38 of the rider and passenger, particularly the inside portion of the rider's and passenger's legs that are adjacent the engine 30 and exhaust system 32.

Referring to FIGS. 1b and 3, in one construction of the side cover assembly 42, the rider can manipulate a switch located near the handlebar 26 from an “off” position to an “on” position to activate the drive member 73 of the fan 72. Likewise, the rider can deactivate the drive member 73 by returning the switch to the “off” position. Furthermore, the side cover assembly 42 can include an override control that automatically activates and deactivates the fan 72 and the drive member 73. For example, the drive member 73 can be automatically activated to drive the fan 72 when the speed of the motorcycle 10 falls below a predetermined value or if the temperature of the engine 30 exceeds a predetermined value. Likewise, the override control can automatically deactivate the fan 72 if the speed of the motorcycle 10 exceeds a predetermined value or if the temperature of the engine 30 falls below a predetermined value. The override control can be actuated when the rider manipulates the switch near the handlebar 26 to an “auto” position.

Referring to FIG. 3, the drive member 73 is activated to drive the fan 72 to draw air from the exterior side 54 of the side cover 44 and through the inlet 76 to define an inlet flow direction generally represented by an arrow 86. The inlet screen 82 inhibits material from traveling from the exterior side 54 and through the fan 72.

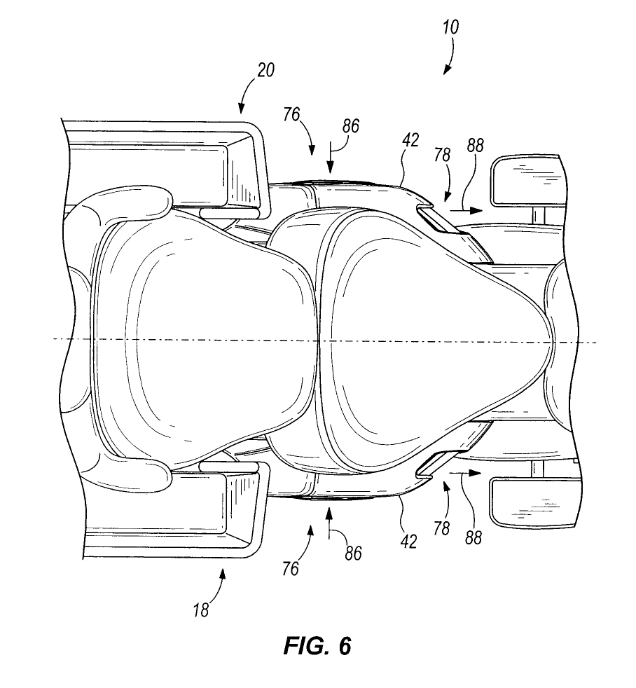

Referring to FIGS. 2 and 3, after the air is drawn through the inlet 76, it travels through the fan 72 and the duct 70 and is discharged through the outlet vent 78 to define an outlet flow direction generally represented by arrows 88. Referring to FIG. 6, in the illustrated construction the outlet flow direction, represented by the arrow 88, is approximately normal to the inlet flow direction, represented by the arrow 86. Furthermore, referring to FIG. 2, the outlet flow directions, represented by the arrows 88, define an angle α with respect to a plane 90 that is parallel to the horizontal plane 28 of FIGS. 1a and 1b. In the illustrated construction, the angle α is between about 10 degrees and about 70 degrees and in other constructions the angle can range between any suitable angles.

Referring to FIGS. 1a and 1b, the air discharged through the outlet vent 78 is directed forward towards the leg 36 of the rider thereby cooling the leg 36 of the rider. In the illustrated construction, the rider's leg 36 is located above and in front of the outlet vent 78 thereby directing the discharged air toward the bottom and back of the rider's leg 36 allowing the air to cool the portion of the rider's leg 36 adjacent the engine 30 and exhaust system 32. Meanwhile, the inlet 76 is located such that the air drawn through the inlet 76 passes over the leg 38 of the passenger thereby cooling the leg 38 of the passenger. Furthermore, the outlet vent 78 and louvers 74 are arranged such that at least a portion of the air discharged through the outlet vent 78 passes over the leg 38 of the passenger.

Referring to FIG. 1a, the side cover assembly 42 is particularly useful when the motorcycle 10 is stopped, as illustrated in FIG. 1a. When the motorcycle 10 is stopped and the rider places their foot on the riding surface, represented by the plane 28, the rider's leg 36 remains above and in front of the outlet vent 78. Thus, air is discharged from the outlet vent 78 toward the bottom and back of the rider's leg 36 to cool the portion of the rider's leg 36 adjacent the engine 30 and exhaust system 32.

Thus, the invention provides, among other things, a side cover assembly 42 configured for use with a motorcycle 10 and operable to cool the rider and passenger of the motorcycle. Various features and advantages of the invention are set forth in the following claims.

What is claimed is:

1. A side cover assembly configured for use with a motorcycle, the side cover assembly comprising:
a side cover adapted to be coupled to the motorcycle, the side cover including,
an interior surface facing an interior side and adapted to face at least a portion of the motorcycle; and
an exterior surface facing an exterior side opposite the interior side;
an inlet at least partially defined by the side cover;
an outlet vent at least partially defined by the side cover; and
a fan assembly coupled to the side cover, the fan assembly operable to draw air from the exterior side and into the interior side through the inlet and discharge at least a portion of the air from the interior side to the exterior side through the outlet vent.

2. The side cover assembly of claim 1, wherein the side cover is generally concave-shaped and includes an outboard wall, an edge spaced from the outboard wall, and side walls connecting the outboard wall to the edge, and wherein the inlet is at least partially disposed in the outboard wall.

3. The side cover assembly of claim 2, wherein the side walls include a first side wall that extends from the outboard wall, and wherein the outlet vent is at least partially disposed in the first side wall.

4. The side cover assembly of claim 3, wherein the side walls include a second side wall that extends from the outboard wall and coupled to the first side wall to define a corner, and wherein the outlet vent is at least partially disposed in the second side wall.

5. The side cover assembly of claim 1, wherein the air drawn through the inlet defines an inlet flow direction and the air discharged through the outlet vent defines an outlet flow direction, and wherein the outlet flow direction is generally normal to the inlet flow direction.

6. The side cover assembly of claim 1, wherein the fan assembly includes a duct coupled to the interior surface of the side cover and adapted to provide fluid communication between the inlet and the outlet vent, and wherein the duct defines a portion of the outlet vent.

7. The side cover assembly of claim 6, wherein the fan assembly further includes a fan positioned within the duct.

8. The side cover assembly of claim 1, wherein the outlet vent includes louvers adapted to direct the air discharged through the outlet vent.

9. The side cover assembly of claim 1, wherein the inlet includes an inlet screen adapted to inhibit material from being drawn from the exterior side and into the interior side through the inlet.

10. A motorcycle comprising:
a frame defining a first side, a second side, a front portion, and a rear portion; and
a side cover assembly coupled to one of the first and second sides, the side cover assembly including a side cover and a fan assembly coupled to the side cover, the fan assembly operable to discharge air in the forward direction.

11. The motorcycle of claim 10, wherein the sider cover assembly further includes,
an inlet at least partially defined by the side cover; and
an outlet vent at least partially defined by the side cover, the outlet vent at least partially opening in the forward direction, wherein the fan assembly is operable to draw air through the inlet and discharge at least a portion of the air through the outlet vent.

12. The motorcycle of claim 11, wherein the air drawn through the inlet defines an inlet flow direction and the air discharged through the outlet vent defines an outlet flow direction, and wherein the outlet flow direction is generally normal to the inlet flow direction.

13. The motorcycle of claim 12, wherein the frame is supported on a surface defining a horizontal plane, the outlet flow direction defining an angle of at least within about 10 to 70 degrees relative to the horizontal plane.

14. The motorcycle of claim 11, wherein the motorcycle is configured to support a rider with a leg positioned above and in front of the outlet vent, and wherein a portion of the air discharged through the outlet vent is directed toward the bottom and back of the leg.

15. The motorcycle of claim 10, wherein the motorcycle includes a seat mounted to the frame and wherein the side cover assembly is coupled to the motorcycle below the seat.

16. The motorcycle of claim 11, wherein the motorcycle is configured to support a passenger with a leg positioned at least partially over the side cover assembly, and wherein the inlet is configured to draw a portion of the air over the leg of the passenger.

17. The motorcycle of claim 16, wherein the leg is positioned adjacent the outlet vent, and wherein the air drawn through the inlet and discharged through the outlet vent is adapted to cool the leg of the passenger.

18. The motorcycle of claim 10, further comprising a user actuable control operable to activate the fan assembly.

19. The motorcycle of claim 18, further comprising an override control operable to disable operation of the fan assembly when one of the speed of the motorcycle exceeds a predetermined value and the temperature of the motorcycle is less than a predetermined value.

20. A method of operating a motorcycle having a side cover that at least partially defines an inlet and an outlet vent, and a fan assembly coupled to the side cover, the method comprising:
activating operation of a fan of the fan assembly;
drawing air through the inlet;
discharging at least a portion of the air through the outlet vent;
directing the air exiting the outlet vent over a leg of a rider of the motorcycle; and
cooling the leg of the rider with the air exiting the outlet vent.

21. The method of operating a motorcycle of claim 20, further comprising,
disabling operation of the fan when one of the speed of the motorcycle exceeds a predetermined value and the temperature of the motorcycle is less than a predetermined value.

22. The method of operating a motorcycle of claim 20, wherein the activating step further includes automatically operating the fan when one of the speed of the motorcycle is less than a second predetermined value and the temperature of the motorcycle exceeds a second predetermined value.

23. The method of operating a motorcycle of claim 20, wherein activating the fan includes manipulating a rider operable switch from a first position to a second position.
